(19) United States
(12) Patent Application Publication
(10) Pub. No.: US 2010/0291903 A1
(43) Pub. Date: Nov. 18, 2010

(54) COMMUNICATION SYSTEM AND/OR A METHOD OF COMMUNICATION

(75) Inventor: Ian McPherson, Essex (GB)

Correspondence Address: THORPE NORTH & WESTERN, LLP., P.O. Box 1219, SANDY, UT, 84091-1219, US

(73) Assignee: DISCRETE COMMUNICATIONS LIMITED, Coventry (GB)

(21) Appl. No.: 12/811,079

(22) PCT Filed: Dec. 29, 2008
(86) PCT No.: PCT/GB08/04297

§ 371 Date: Jun. 28, 2010

(30) Foreign Application Priority Data
Dec. 28, 2007 (GB) 0725330.5

(51) Int. Cl. H04L 12/58; G06K 9/00; H04M 1/00; H04M 3/42

(52) U.S. Cl. 455/412.1; 382/103; 455/556.1; 455/414.1

(57) ABSTRACT

A communication system comprises: means for automatically recognizing the vehicles numbers present on vehicle plates; means for storing data representative of a driver's personal contact details and vehicle number plates; means for matching a recognized vehicle number plate with said stored data; and means for sending one or more signals to said driver.

### FIELD OF THE INVENTION

The invention relates to communication systems and methods of communication.

### BACKGROUND TO THE INVENTION

Conventional automatic number plate recognition systems employ a camera which grabs an image and through analysis derives and records the vehicle number in order to be able to identify vehicles and assign a time of their interaction with the recognition system. This allows useful security data to be gathered in order to provide information about the individuals who accessed a particular neighbourhood to security firms or the police should they need to investigate.

The following prior art documents are acknowledged:

### WO00/70504, KR200691789, KR200694243, and GB2217498.

WO00/70504 focuses on providing a network of beacon-style devices which generate signals that can be detected through wireless technology in order to harvest geographical information which builds up a profile for customers. License plate scanning with cameras is mentioned as a potential form of harvesting location information. However, in that embodiment the information is delivered to displays which are generally public displays. Whilst a completely passive beacon system is envisaged by the automatic detection of license plate numbers on vehicles, there is no single embodiment showing the combination of passive detection and individually sending mobile communication to an individual's mobile receiving unit. In the embodiment of page 9 where the display may be a cellular telephone, the cellular telephone is used as a beacon as well as a user terminal device. The system therefore requires complex detection means to be provided in each mobile phone system. A number of difficulties arise when mobile phones are not available since the network coverage often does not penetrate into large structures such as an underground car park. One of the technical objects of the invention is to for example, improve the reliability of detection followed by contact with an individual even when vehicles are in locations such as underground car parks, multi-story car parks or tunnels. Another technical object of the invention is for example to be able to contact only a small relative number of individuals compared to the total numbers of mobile phone numbers. It also overcomes the problems of sending information to individual mobile phones in a given cell. In certain cells there may be large numbers of users therefore the accuracy of the contact based on the prior art system is relatively poor.

### SUMMARY OF THE INVENTION

In a first broad independent aspect, the invention provides a method of operating a computing device comprising the steps of:
storing data representative of a driver's mobile phone number and vehicle number plates;
receiving signals representative of a recognized vehicle number plate;
matching a recognized vehicle number plate with said stored data; and
only sending one or more signals to said driver via a mobile communication network if said computing device matches said recognized vehicle number plate with said stored data.

This configuration is particularly advantageous because it allows an improvement in the reliability of the contact of an individual. It allows a very small number of individuals to be targeted relative to the millions of available mobile telephone numbers. It also allows contact to be achieved inside structures where active tags can't function. It therefore allows a more rapid response particularly if in one embodiment the device for capturing vehicle number plates is coupled with a mobile network repeater. The repeater may be of a kind which repeats signals to and from an interior space.

In a subsidiary aspect, said signals when processed by a mobile communication device take the form of a text message.

In a further subsidiary aspect, said signals when processed by a mobile communication device take the form of one or a succession of images.

In a further subsidiary aspect, said signals when processed by a mobile communication device take the form of an audio message.

In a further subsidiary aspect, the method further comprises the steps of logging the time of vehicle number recognition and selecting a signal dependent upon the time elapsed since the time of vehicle number recognition.

This configuration is particularly advantageous because it further increases the probability of reliable communication between the system and an individual and their mobile phone.

It avoids the likelihood of a user in a multi-story car park receiving a specific message only after retrieval from a voice box. It also allows the information to have improved commercial effects since the timing of the advert may be at a point in time which could advantageously influence a potential purchasing decision of the mobile phone user.

In a second broad independent aspect, the invention provides a communication system comprising:
means for automatically recognizing the vehicle's numbers present on vehicle plates;
means for storing data representative of a driver's personal contact details and vehicle number plates;
means for matching a recognized vehicle number plate with said stored data; and
means for sending one or more signals to said driver.

The system allows communication with a driver. It allows a more rapid dispatch of signals to a driver than conventional systems without significant infrastructure modifications other than the provision of said means for automatically recognizing the vehicle's numbers present on vehicle plates.

The term “driver” is not to be interpreted narrowly. It covers the driver whilst in the vehicle or outside of the vehicle. Other suitable terms may be used instead, such as a user or an operative. The system may have the secondary advantage of allowing information to be communicated to a driver without the driver having to publicly disclose his personal contact details. In the context of recognition in a supermarket car park, this will allow the communication with a driver to occur pre-till without the requirement of necessarily installing a Bluetooth system in a particular store. This also teaches against prior art Bluetooth systems since these are generally reliant on the consumer activating their Bluetooth system whereas the communication through the system of the main broad is independent aspect allows communication without a driver necessarily having to switch from a conventional mobile phone operation to a Bluetooth mode of operation.

In a subsidiary aspect in accordance with the invention's first broad independent aspect, said means for sending is adapted to send one or more signals which when processed by a mobile communication device take the form of a text message. This configuration is particularly advantageous because it allows communication to occur directly with the driver without requiring any particular upgrade to his/her mobile phone. It therefore enables promotional campaigns to reach their target pre-till without requiring any specific upgrade to existing mobile phones.

In a further subsidiary aspect, said means for sending is adapted to send one or more signals which when processed by a mobile communication device take the form of one or a succession of images. This would allow in one embodiment at least for a user or driver to immediately visualise that a promotion is available. It may also allow a driver to engage with a remote database to identify further similar promotions.

In a further subsidiary aspect, said means for sending is adapted to send one or more signals which when processed by a mobile communication device take the form of an audio message. This may take for example the form of a voice mail with observations which a registered user wishes to send to a further registered user. The content of the audio message will of course vary dependent upon the motive of the interaction with the system.

In a further subsidiary aspect, said means for automatically recognising the vehicle's numbers is also adapted to recognize insurance and/or tax disc information displayed on said vehicle.

This configuration is particularly advantageous because it would allow promotional information to be sent to a registered driver at the appropriate time with regard to his/her annual insurance premium and the renewal of his/her tax disc.

In a further subsidiary aspect, said system incorporates a first database which is part of said means for storing data representative of information concerning a driver; and at least a second and separate database which contains venue and/or event specific data from which said means for sending signals to a driver extracts venue and/or event specific data. This would allow a venue such as a car park to communicate directly with a driver, for example in terms of promotion or in terms of security. This would allow the communication to be tailored specifically to the location where the vehicle's numbers have been recognised.

In a further subsidiary aspect, said system incorporates at least two separate means for storing data representative of information concerning a driver; a first being a database of vehicle plate numbers and driver's personal contact details; and a second being a database of a shopping profile of a vehicle driver. This system would allow the communication to be statistically more accurate and pre-till. The communication wilt thus be tailored to an individual and communicated more rapidly than any prior art mail advertisement campaigns or general in-store campaigns.

In a further subsidiary aspect, said system incorporates means for automatically recognizing the vehicle's numbers present on vehicle plates both at the entry of a particular venue and at the exit. This allows the system to quantify the length of time an individual interacts with a particular venue in order to further optimise the accuracy of any pre-till campaign.

In a further subsidiary aspect, said means for automatically recognising vehicle's numbers is adapted to extract a list of numbers and said means for matching matches a plurality of recognized vehicle number plates with said stored data. This system is particularly advantageous because it allows an operation in batches in order to improve the efficiency of communication between the various stages in the system. It also allows a general advertising board to be adjusted in accordance with a group profile rather than an individual's profile.

In a further subsidiary aspect, said system further comprises a display unit incorporating means for facilitating wireless communication with said display unit; and said means for sending signals sends signals which when processed by said display unit are displayed in the form of an advertisement. This would allow general advertisement boards, for example, to be adjusted remotely dependent upon individuals having entered a supermarket car park.

In a further subsidiary aspect, the communication system further comprises means for logging the time of vehicle number recognition and means for selecting a signal dependent upon the time elapsed since the time of vehicle number recognition.

This configuration is particularly advantageous because it allows the timing of the signals sent to a driver to be optimised. It also allows different promotions to be sent at different time periods based on the time of vehicle number recognition and on the likely progression of an average customer in a given shop.

In a third broad independent aspect, the invention provides a communication system comprising:
an electronic data entry field for facilitating an entry of a vehicle number by an individual and/or event operative and/or venue operative having identified a vehicle number;
means for sending one or more signals destined for the driver;
means for storing data representative of a driver's personal contact details and vehicle number plates; and
means for facilitating the communication between said individual and/or event operative and/or venue operative and said driver.

This system allows individuals to communicate with one another without first exchanging any personal details. It therefore reverses conventional thinking as it allows communication to be initially based on the number plates. It also improves the rapidity of communication between an event operative and a driver during a particular event. It also avoids having to supply personal information to a large group of disparate organisations.

In a subsidiary aspect in accordance with the invention's second broad independent aspect, said means for facilitating the communication between said individual and/or event operative and/or venue operative and said driver is activated only if the individual and/or event and/or venue; and the driver are registered in said means for storing data.

This prevents the user's information from being disseminated outside of the system or in multiple separate locations.

In a further subsidiary aspect, the system further comprises means for storing a message sent to a particular vehicle number if the driver is not registered in said means for storing data; and means for communicating said message to said driver after said driver registers in said means for storing data. This allows for unsent messages to be held back for a period of time at least until both the sender and the recipients are registered.

In a fourth broad independent aspect, the invention provides a method of communication comprising the steps of:
automatically recognizing the vehicle's numbers present on vehicle plates;
storing data representative of a driver's personal contact details and vehicle number plates;
matching a recognized vehicle number plate with said stored data; and
sending one or more signals to said driver.

This method is particularly advantageous because it allows communication to be established without personal contact details being freely distributed. It also allows communication to be established directly with a driver based on the recognition of the vehicle's numbers. It achieves an increase in the rapidity and accuracy of the communication.

In a subsidiary aspect in accordance with the invention's third broad independent aspect, the invention provides the step of sending one or more signals which when processed by a mobile communication device take the form of a text message. This allows direct communication to be established with a mobile communication device in a readily accessible format without requiring upgrades to recent technologies. The communication method therefore has the ability to reach a greater number of drivers in a more direct form than previously and in a shorter timescale.

In a further subsidiary aspect, the method further comprises the step of sending one or more signals which when processed by a mobile communication device take the form of one or a succession of images.

In a further subsidiary aspect, the method further comprises the step of sending one or more signals which when processed by a mobile communication device take the form of an audio message.

In a further subsidiary aspect, the method further comprises the step of recognizing insurance and/or tax disc information displayed on said vehicle.

In a further subsidiary aspect, the method further comprises the step of extracting venue and/or event specific data and sending signals to a driver dependent upon said venue and/or event specific data.

In a further subsidiary aspect, the method further comprises the step of sending signals to a driver dependent upon a driver's shopping profile.

In a further subsidiary aspect, the method further comprises the step of automatically recognizing the vehicle's numbers present on vehicle plates both at the entry of a particular venue and at the exit.

In a further subsidiary aspect, the method further comprises the steps of extracting a list of numbers and matching a plurality of recognized vehicle number plates with said stored data.

In a further subsidiary aspect, a display unit incorporating means for facilitating wireless communication with said display unit is provided; and the method sends signals which when processed by said display unit are displayed in the form of an advertisement.

In a further subsidiary aspect, the method further comprises the steps of logging the time of vehicle number recognition and selecting a signal dependent upon the time elapsed since the time of vehicle number recognition.

In a fifth broad independent aspect, the invention provides a method of communication comprising the steps of:
providing an electronic data entry field for facilitating an entry of a vehicle number by an individual and/or event operative and/or venue operative having identified a vehicle number;
sending one or more signals destined for the driver;
storing data representative of a driver's personal contact details and vehicle number plates; and
facilitating the communication between said individual and/or event operative and/or venue operative and said driver.

In a subsidiary aspect in accordance with the invention's fourth broad independent aspect, the method further comprises the step of activating the communication between said individual and/or event operative and/or venue operative and said driver only if the individual and/or event and/or venue; and the driver are registered.

In a further subsidiary aspect, the method further comprises the steps of storing a message sent to a particular vehicle number if the driver is not registered; and communicating said message to said driver after said driver registers.

### BRIEF DESCRIPTION OF THE FIGURES

FIGS. 1a and 1b show respectively the first and second half of a flow chart of a first embodiment of the invention.

FIG. 2 shows an alternative embodiment of the invention in the form of a flow chart.

FIG. 3 shows the first part of a flow diagram.

FIG. 4 shows the second part of a flow diagram.

### DETAILED DESCRIPTION OF THE FIGURES

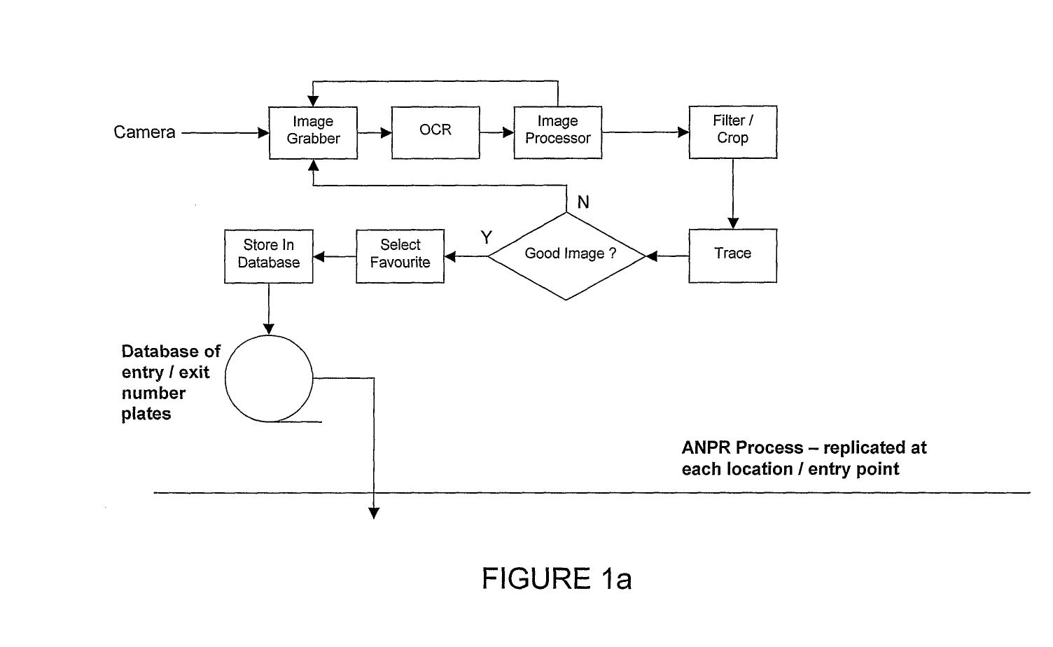

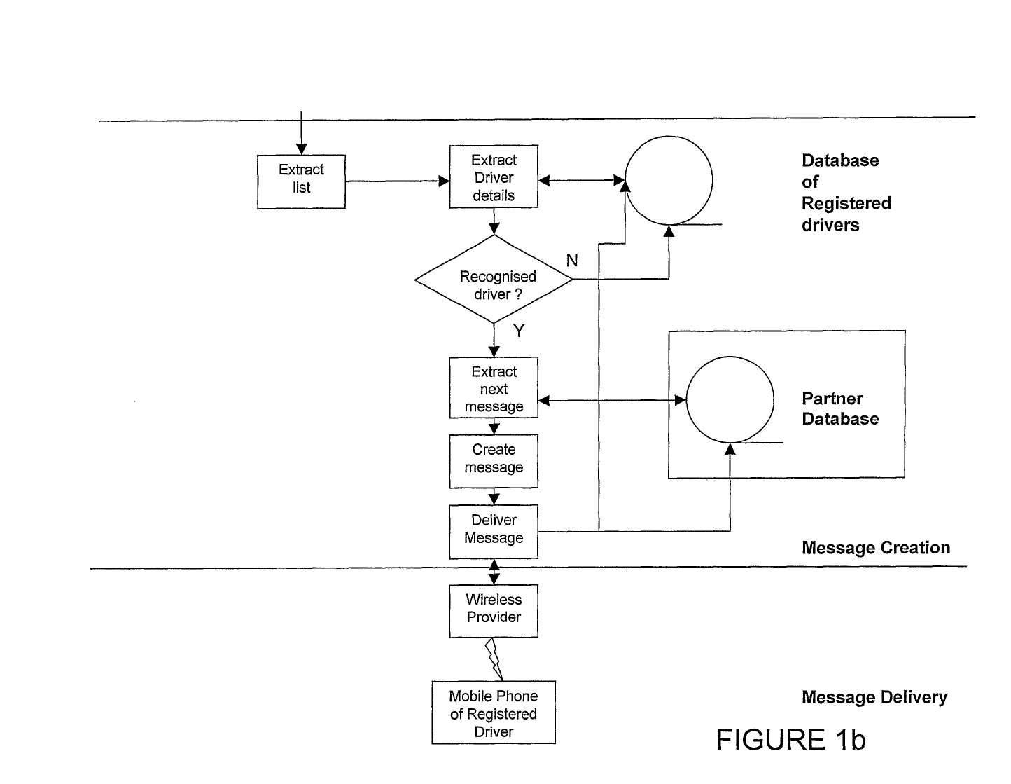

FIG. 1 shows a communication system incorporating means for automatically recognising the vehicle's numbers present on vehicle plates in the form of a camera. The camera incorporates an image grabber. The image obtained by the camera is then submitted to an optical character recognition system (OCR). The image processor then carries out a number of operations such as: filter, crop and trace. It also evaluates whether the image is ultimately a good image. If the image does not meet the required quality level an alternative image will be sourced from the image grabber if available. A favourite image is selected and then stored in the database. The database produces lists of vehicle numbers and the time at which the camera captured the image. The previously described automatic number plate recognition process would be replicated at each location and/or entry point.

A communication line is established between the database of number plates obtained from the recognition process with the database of registered drivers in order to extract driver details. If the driver is not recognised then this information is added to the database as a driver which has not been recognised but has interacted with the system. If on the other hand, the driver is recognised, then a message may be sent to the driver. The message sent to the driver will be dependent upon a given partner database. For example, if the automatic number plate recognition process took place at the entry point of a supermarket such as Sainsbury's, the partner database may be the “Nectar” database which includes details with regard to the driver's shopping pattern and potential promotions for a particular driver's profile. Based on the identification of a particular driver, the partner database would produce an advertisement message such as “buy one get one free of product X”. The message may also incorporate a promotional code which could be validated at the checkout by the till operative so that the promotion is available only to the driver interacting with the system.

The message may be delivered by “SMS” (short messaging service) to the mobile communication device such as the mobile phone of the driver. Due to mobile communication being applied throughout the communication between the various components of the system may be particularly rapid in order to allow promotions to arrive at the appropriate time during the purchasing process.

The terms “means for storing data” may incorporate remote or local databases which may be accessible via the internet or any other access route. The storage means may also be a temporary storage means and/or an evolving storage means. These terms may incorporate within their scope such devices as floppy discs, keys, hard drives and random access memory.

The “means for matching” may also be a system for comparing vehicle number plates with personal contact details. This may be controlled through a number of protocols or algorithms designs specifically to achieve the object defined in the claims.

The term “means for sending” may also be given a broad meaning and may for example include devices such as a wireless network and a database with predetermined messages with a controller for selecting which predetermined message would be most appropriate for a particular driver and automatically sending the message. Another form of sending a message may be to employ a display unit such as a television screen or an advertisement board showing specifically tailored advertisements to a driver whose number plate has been recognised.

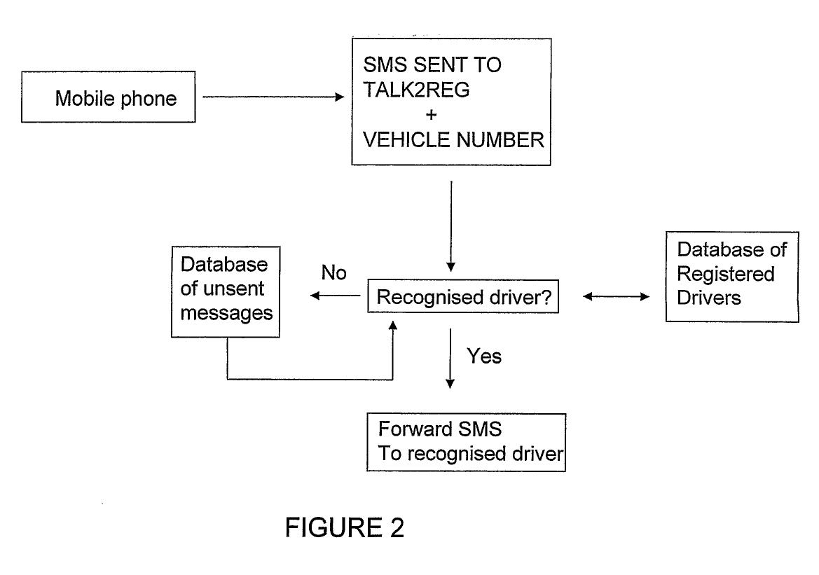

FIG. 2 shows a further example of a communication system for communicating with a driver of a vehicle. The method illustrated is via “SMS” (short messaging service). Instead of relying on “SMS” the system may employ voice. Other services such as “MMS” (Multimedia Messaging Service) may be employed as part of this method or any of the methods described in the application.

In the system of FIG. 2, an individual who wishes to enter into contact with a driver observes the number plate and sends a text message to the system operator “Talk2Reg”. The operator then checks against the database of registered drivers in order to identify whether the driver is recognised. If it is not, then the message sent is stored in the database of unsent messages which periodically polls the recognised driver database to find whether the unsent messages can now be forwarded on or they must be deleted if they have been held for a period which is longer than the period set in the system. If the driver is recognised the “SMS” is forwarded to the driver. The driver may then continue communication system.

This system allows registered users to communicate with one another. The system may handle in/outbound messages based on these rules. Communication is private and secure for both parties as it is the registration plate that is used to identify both sender and receiver. The mobile number is never given publicly in this embodiment. To enable validation of the driver, pending a dispute over who owns the number plate, the system provides for the VIN to be obtained and stored from the DVLA allowing cross checking with the vehicle and/or V5 Log Book to prove the rightful owner.

This system may also be employed for automating the payment for parking using automatic number plate recognition on entry and exit or adding extra security allowing car park operators to contact the customer whilst away from the vehicle.

The system may also be deployed to allow an event organiser to contact customers who have parked or are visiting the event. Contact could be to confirm charging for parking or event access or to communicate with the customer whilst away from the vehicle for security reasons. Secure parking for any event with a small infrastructure may also be provided.

The system also lends itself to improvements to commuter parking since whilst the car is parked in the commuter car park all day the driver becomes contactable from the car park operator or another individual via the system.

In addition, in a park and ride application, any registered car parked in the park and ride car park would be contactable through the system either through the operator or any other individual for means of promotions or security.

In another application, it allows individuals to contact any vehicle anywhere for any reason as long as it is registered.

In a hotel application, this system would allow contact to customers of the hotel car park for security or charging.

A further application where the system would be deployed in conjunction with a petrol station forecourt, the system would benefit the security by providing information based on registered users. It would also allow tracking of customers and participation of promotions. The system would also have benefits for the police by tracking via a nation-wide system of “ANPR” cameras tied into the central database of the system to provide an accurate location of a vehicle number plate.

It would also be beneficial for existing systems such as the congestion charge in order to allow instant charging or any other road toll based system.

It is also thought to have particular benefits in the application for disabled parking in which context car park operators, councils etc would be able to communicate with drivers who may be wrongly parked.

The system would also be equipped with a facility for a registered user to update his/her vehicle details. This would allow the system to be more rapidly up to date than having to rely on other systems.

It would also allow car owners, service providers and retailers to maintain contact with customers with that number plate.

The system would therefore have particular applications for manufacturers, retailers, service and repair, MoT garages, car insurance, accessories, police and councils, speeding fines, instant notification for breakdown and recovery services.

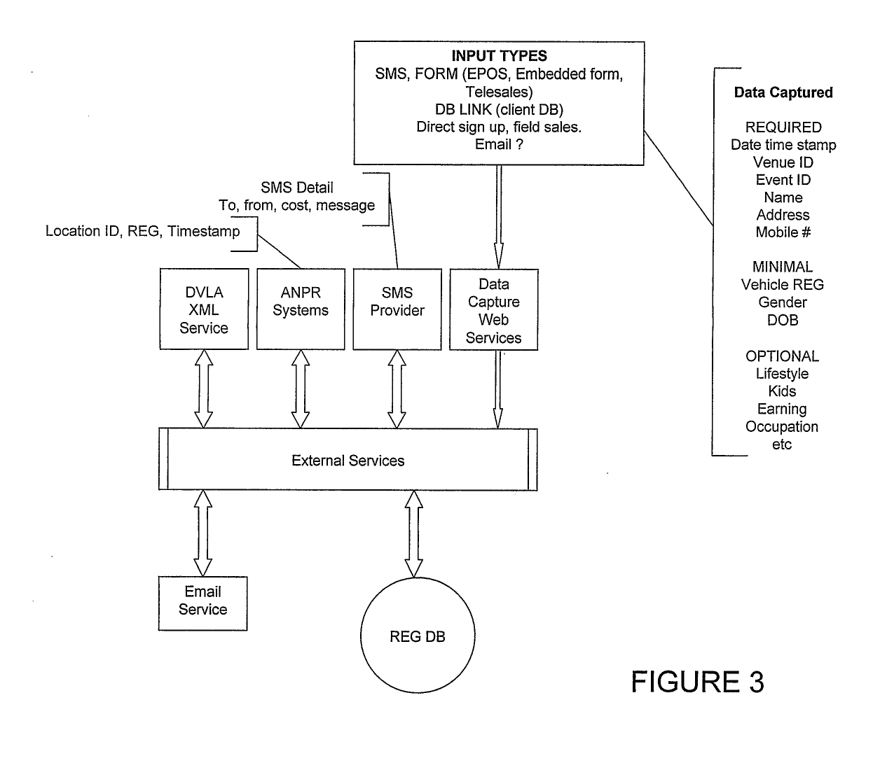

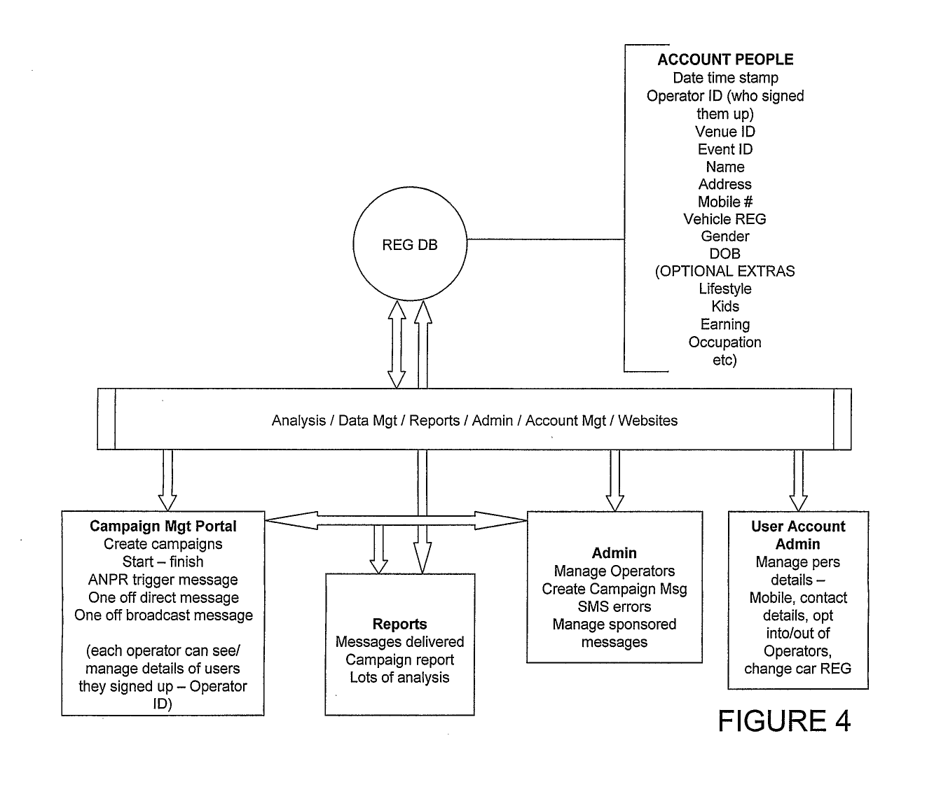

FIG. 3 shows the first part of an embodiment of the invention. In order to reliably contact an individual a number of inputs are provided which when processed improved contact with an individual is achieved. By using automatic number plate recognition systems and configuring them to send information with regards to location, registration numbers and time stamp, a large portion of the required variables are contributed. Further required data is obtained from a vehicle licensing authority which provides name, address and mobile numbers. In order to carefully select the kind of information sent to an individual the variables may be for example the vehicle registration number itself, gender and the individual's date of birth. A number of further variable capturing means may be employed such as loyalty card data to refine the kind of data sent to an individual dependent upon lifestyle, age group, earnings, occupation etc. The system may employ the following input types for additional data capturing: SMS, Form (EPOS embedded form, telesales), a database link to a particular client database, direct sign up, field sales, and emailing. An SMS provider may be employed to facilitate the communication to and from the system and an individual. Mathematical models may be employed in the selection process of particular kind of data to send to an individual to improve the data's effectiveness.

The database may be employed in an account people context to record: date time stamp, operator ID (for example who signed them up), the new ID, event ID, name, address, mobile number, vehicle registration number, date of birth, lifestyle, kids, earning, occupation etc.

A number of accounting reports may be produced and transmitted to various portals such as: campaign management portal, administration, user account administration and for any other kind of report. The campaign management portal may be employed to create campaigns from start to finish, to allow automatic number plate recognition to trigger a message, to trigger a one off direct message, to broadcast a one off message. This would also allow each operator to oversee and manage details of users they signed up. The reports may take the form of messages delivered, campaign reports, and further analysis if required. An administration function may be employed to manage operators, create campaign messages, assess SMS errors, and manage sponsored messages. The user account administration may be employed to manage personal details, mobile, contact details, opt into/out of operators, and change car registration.

In a further embodiment, the database as described previously may also obtain GPS marketing data.

In an exemplarily embodiment the automatic number plate recognition systems may be configured to allow the system operator to take a data feed directly into an existing database through one of the following interfaces: web services, FTP etc. SMS may be provided from existing providers. In a preferred embodiment WIN PLC s SMS service may be configured to allow for multi-threaded delivery of large volumes of messages. This is particularly advantageous for large events with many identified individuals.

In a further embodiment of the invention, a mobile phone application is configured to either be proactive or reactive in sending location back to the system in addition to the location data obtained by automatic number plate recognition.

The delivery of relevant content may be via multiple channels and/or employ methods in real-time. The following channels are particularly advantageous:
SMS with two way interaction;
Barcodes via web pages or SMS delivery;
WAP links;
Mobile web pages—optimised for the mobile device and personalised to the subscribers;
MMS; and
Enriched media content.

1-35. (canceled)

36. A method of operating a communication system comprising the steps of:
storing data representative of a driver's mobile phone number and vehicle number plates;
employing a camera for grabbing an image; and applying optical character recognition;
receiving signals representative of a recognized vehicle number plate;
matching a recognized vehicle number plate with said stored data; and
only sending a signal to said driver via a mobile communication network if said computing system matches said recognized vehicle number plate with said stored data.

37. A method according to claim 36, comprising the step of logging the time of vehicle number recognition.

38. A method according to claim 36, comprising the step of selecting a signal dependent upon a period of time which elapsed since the time of vehicle number recognition.

39. A method according to claim 38, comprising the step of dispatching a signal at an elapsed time.

40. A method according to claim 36, comprising the steps of filtering, cropping and tracing images.

41. A method according to claim 36, comprising the step of storing data in the form of a selected image.

42. A method according to claim 36, wherein said signals when processed by a mobile communication device take the form of one of: a text message, an image, a succession of images, and an audio message.

43. A communication system comprising:
a camera for automatically recognizing the vehicle's numbers present on vehicle plates;
said camera incorporating an image grabber; and a processor for applying optical character recognition;
a data storage for storing data representative of a driver's personal contact details and vehicle number plates;
a processor for matching a recognized vehicle number plate with said stored data; and
a controller configured to only send a signal to said driver via a mobile communication network if said communication system matches said recognized vehicle number plate with said stored data.

44. A communication system according to claim 43, comprising a data logger for logging the time of vehicle number recognition.

45. A communication system according to claim 43, comprising a controller for selecting a signal dependent upon a period of time which elapsed since the time of vehicle number recognition.

46. A communication system according to claim 45, wherein said controller is configured to dispatch a signal at an elapsed time.

47. A communication system according to claim 43, wherein said signals when processed by a mobile communication device take the form of one of: a text message, an image, a succession of images, and an audio message.

48. A communication system according to claim 43, wherein said system incorporates a first database for storing data representative of information concerning a driver; and at least a second and separate database which contains one of venue and event specific data from which said controller extracts one of venue and event specific data.

49. A communication system according to claim 43, wherein said system incorporates at least two separate databases for storing data representative of information concerning a driver; a first being a database of vehicle plate numbers and driver's personal contact details; and a second being a database of a shopping profile of a vehicle driver.

50. A communication system according to claim 43, wherein said system incorporates cameras for automatically recognizing the vehicle's numbers present on vehicle plates both at the entry of a particular venue and at the exit.

51. A communication system comprising:
an electronic data entry field for facilitating an entry of a vehicle number by one of an individual, an event operative and a venue operative having identified a vehicle number;
a mobile phone for sending a signal destined for the driver;
a database for storing data representative of a driver's personal contact details and vehicle number plates; and
means for facilitating the communication between one of said individual, event operative, and venue operative; and said driver.

52. A communication system according to claim 51, wherein said means for facilitating the communication between one of said individual, event operative, and venue operative and said driver is activated only if one of the individual, event and venue; and the driver are registered in said database.

53. A communication system according to claim 51, further comprising a database for storing a message sent to a particular vehicle number if the driver is not registered in said database for storing data; and a controller for communicating said message to said driver after said driver registers in said database.

54. A method of communication comprising the steps of:
providing an electronic data entry field for facilitating an entry of a vehicle number by one of an individual, an event operative, and a venue operative having identified a vehicle number;
sending at least one signal destined for the driver;
storing data representative of a driver's personal contact details and vehicle number plates; and
facilitating the communication between one of said individual, event operative, and venue operative; and said driver.

55. A method of communication according to claim 54, further comprising the step of activating the communication between one of said individual, event operative, and venue operative; and said driver only if one of the individual, event and venue; and the driver are registered.

56. A method of communication according to claim 54, further comprising the steps of storing a message sent to a particular vehicle number if the driver is not registered; and communicating said message to said driver after said driver registers.
